(19) United States
(12) Patent Application Publication
(10) Pub. No.: US 2016/0034243 A1
(43) Pub. Date: Feb. 4, 2016

(54) Modular Computers and Related Methods

(71) Applicant: Banke Agarwal, St. Louis, MO (US)

(72) Inventor: Banke Agarwal, St. Louis, MO (US)

(21) Appl. No.: 14/812,564

(22) Filed: Jul. 29, 2015

Related U.S. Application Data
(60) Provisional application No. 62/030,737, filed on Jul. 30, 2014.
(60) Provisional application No. 62/132,696, filed on Mar. 13, 2015.

(51) Int. Cl. G06F 3/14; G06F 3/02; G09G 5/00

(52) U.S. Cl. CPC G06F 3/1446; G09G 5/003; G06F 3/0202; G06F 3/0227; G09G 2370/16

(57) ABSTRACT

A computer includes a processor and first and second screen panels. The processor is provided in the first screen panel. The computer also includes a connector hinge by which the first and second screen panels are reversibly connected with each other. The screen panels each are individually capable of performing wireless communication.

### CROSS-REFERENCE TO RELATED APPLICATIONS

This application claims the benefit of U.S. Provisional Application No. 62/030,737, filed on Jul. 30, 2014, and U.S. Provisional Application No. 62/132,696 filed on Mar. 13, 2015. The entire disclosures of each of the above applications are incorporated herein by reference.

### FIELD

The present disclosure relates to modular computers and related methods.

### BACKGROUND

This section provides background information related to the present disclosure which is not necessarily prior art.

Many people find laptop computers to be indispensable for business and/or personal computing. A laptop computer can provide portability as well as a screen and keyboard that are more convenient to use than those of smart phones and other mobile devices.

### SUMMARY

This section provides a general summary of the disclosure, and is not a comprehensive disclosure of its full scope or all of its features.

In one example embodiment, the disclosure is directed to a computer that includes a processor and first and second screen panels. The processor is provided in the first screen panel. The computer also includes a connector hinge by which the first and second screen panels are reversibly connected with each other.

In one example implementation, a method of operating a computer includes disconnecting at least one of a pair of screen panels from a connector hinge of the computer, and operating a processor of at least one of the screen panels so as to provide wireless communication between the disconnected screen panels.

In another example embodiment, a modular computer includes two screen panels, a processor in one of the screen panels, and a connector hinge to which the screen panels are connectible. At least one of the panels is removable from the connector hinge. The modular computer is configurable to provide operability as (a) a laptop computer having one or two screens, (b) a single tablet computer, and/or (c) a desktop computer with one or two screens.

In yet another example embodiment, a keyboard has an upper portion, a lower portion, and a key area between the upper and lower portions. The upper and/or lower portions are foldable relative to the key area.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of a modular computer in accordance with one embodiment of the disclosure;

FIG. 2A is a cross-sectional view of a connector hinge of a modular computer in accordance with one embodiment of the disclosure;

FIG. 2B is a view of the connector hinge shown in FIG. 2A, the view taken along lines 2B in FIG. 2A and showing a connector switch in accordance with one embodiment of the disclosure;

FIG. 2C is a view of another example connector switch of a modular computer in accordance with one embodiment of the disclosure;

FIG. 3 is an illustration of a modular computer configured as a laptop computer in accordance with one embodiment of the disclosure;

FIGS. 4A and 4B are illustrations of removal of a keyboard from between screen panels of a computer in accordance with one embodiment of the disclosure;

FIGS. 5A and 5B are illustrations of a reconfiguration of a laptop computer to obtain a tablet in accordance with one embodiment of the disclosure;

FIG. 6A through 6C are illustrations of a reconfiguration of a laptop computer to obtain a tablet in accordance with one embodiment of the disclosure;

FIG. 7A through 7C are illustrations of various desktop configurations of a modular computer in accordance with various embodiments of the disclosure;

FIG. 8 illustrate a foldable keyboard in accordance with one embodiment of the disclosure;

FIG. 9A is a top view of a connector hinge of a modular computer in accordance with one embodiment of the disclosure;

FIG. 9B is a cross-sectional view of a connector hinge of a modular computer in accordance with one embodiment of the disclosure;

FIG. 9C is a is a view of the connector hinge shown in FIG. 9B, the view taken along lines 9C in FIG. 9B and showing a connector switch in accordance with one embodiment of the disclosure;

FIG. 10A is a top view of a connector hinge of a modular computer in accordance with one embodiment of the disclosure;

FIG. 10B is a cross-sectional view of a connector hinge of a modular computer in accordance with one embodiment of the disclosure; and

FIG. 10C is a view of the connector hinge shown in FIG. 10B, the view taken along lines 10C in FIG. 10B and showing a connector switch in accordance with one embodiment of the disclosure.

Corresponding reference numerals indicate corresponding parts throughout the several views of the drawings.

### DETAILED DESCRIPTION

Example embodiments will now be described more fully with reference to the accompanying drawings.

The inventor has observed that laptop computers are available that are equipped with two screens, but the computers tend to have limitations. In one such laptop, one of the screens is used to provide a virtual keyboard that can be inconvenient to use. Other laptops have been provided with two screens where one screen is smaller than the other.

Accordingly, the inventor has developed and discloses herein exemplary embodiments of a modular computer having a processor and two screen panels, the processor being provided in one of the screen panels. The screen panels are reversibly connectable with each other by a connector hinge. In various embodiments a keyboard is provided that can be reversibly inserted between the screen panels. In various embodiments the screen panels and keyboard are individually capable of communicating wirelessly. In accordance with various aspects of the disclosure, a modular computer may be used as a laptop computer having one or two screens, as a single tablet computer, and/or as a desktop computer having one or two screens.

Unless otherwise indicated, the term “modular computer” is used to refer to a plurality of physical units or components that can be reversibly combined and/or interchanged to provide various computing capabilities and/or computing configurations. It should be noted that in various embodiments of the disclosure, a given physical unit or component may provide a desired computing capability without having to be physically connected with other physical units or components. It also should be noted that in various embodiments of the disclosure, a physical unit or component may perform wireless and/or wired communication with another physical unit or component.

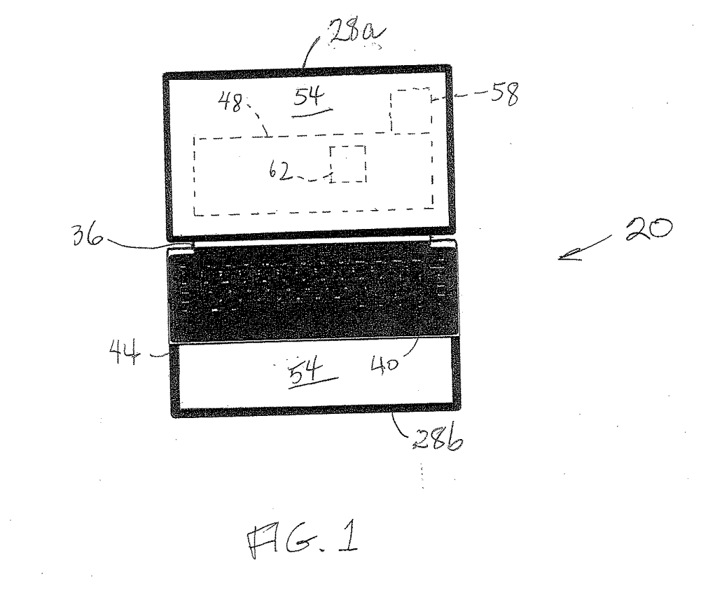

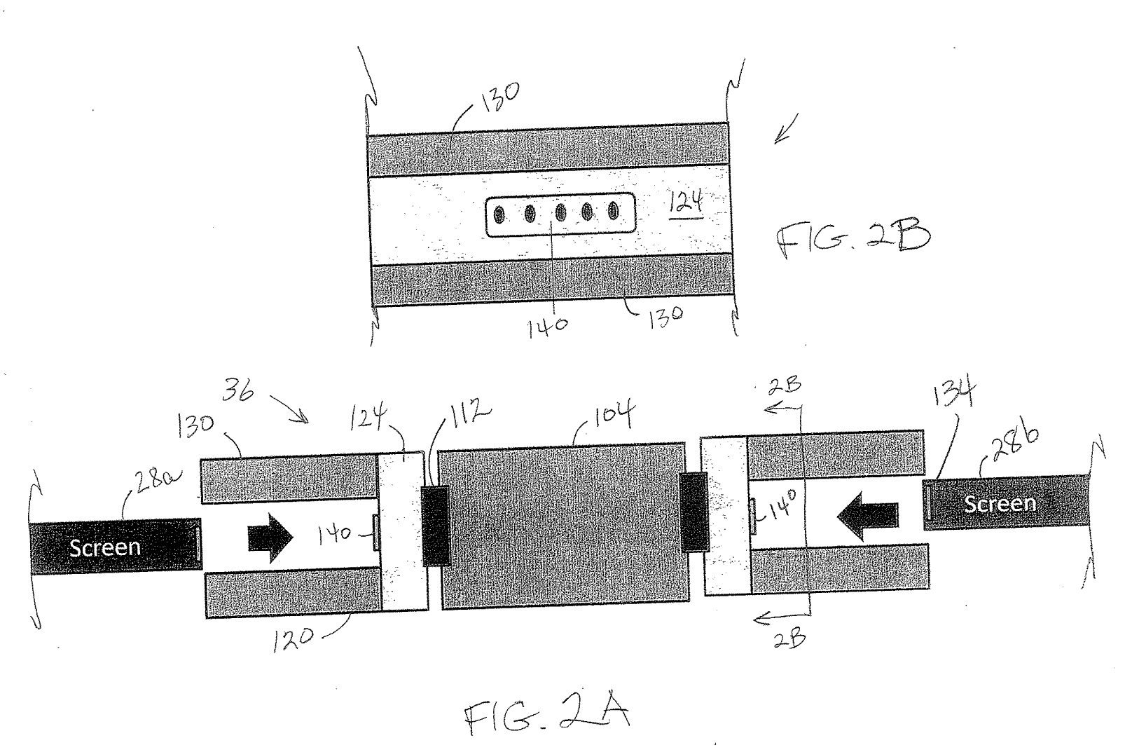

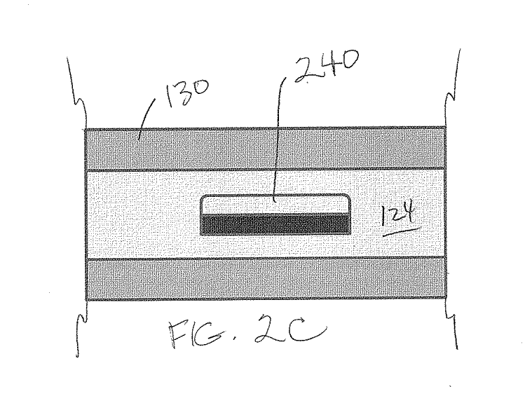

With reference now to the figures, FIGS. 1, 2A and 2B illustrate an exemplary embodiment of a modular computer embodying one or more aspects of the present disclosure. As shown in FIG. 1, a modular computer 20 includes two screen panels 28a and 28b (collectively referred to by reference number 28.) The screen panels 28 are reversibly connected by a connector hinge 36. A keyboard 40 may be housed between the screen panels 28 and may be removed by a user, e.g., to perform wireless communication with the screen panel(s) 28. The keyboard 40 has a battery and transmitter/receiver (not shown) and may also be connectable with and detachable from the connector hinge 36. Additionally or alternatively, the keyboard 40 may be reversibly attached, e.g., clipped, to edges 44 of one of the screen panels 28, e.g., to edges 44 of the screen panel 28b as shown in FIG. 1.

Each of the screen panels 28 includes a printed circuit board (PCB) 48 between a display screen 54 and an external cover (not shown in FIG. 1). In the present example embodiment the display screens 28 are touch screens. Each PCB 48 is powered by a battery (not shown) and includes a transmitter/receiver 58 for wireless communication. A processor 62 with memory is provided, e.g., on the PCB 48 in the screen panel 28a, although in other embodiments the processor 62 could be provided in the other screen panel 28b. It also is contemplated, e.g., that two processors could be provided, one in each screen panel 28. In the example modular computer 20, at least one of the screen panels 28 has functionality not illustrated in FIG. 1, including but not necessarily limited to a solid-state hard drive, speaker, GPS (Global Positioning System) functionality, accelerometer, camera, UCB port(s), etc. It will be appreciated that in various modular computer embodiments, it is possible to provide various combinations and configurations of functionalities, components, etc. in one and/or the other of two screen panels.

The connector hinge 36 is shown in greater detail in FIGS. 2A and 2B. The connector hinge 36 includes a central hinge portion 104. At least two opposed connectors 112 are snugly connected with the central hinge portion 104 and movable relative to the central hinge portion 104, e.g., rotatable at least partially around the central hinge portion 104 and toward or away from each other. Although the central hinge portion 104 is shown in FIG. 2A as having a rectangular edge profile, in other embodiments a central hinge portion may have another edge profile. For example, a central hinge portion may be cylindrical in shape, have an elliptical edge profile, etc.

Attached to each movable connector 112 is one of two screen panel support structures 120. Each screen panel support structure 120 has a spine 124 attached to one or more movable connector 112. Two supporting blades 130 extending from a given spine 124 are configured to receive a screen panel 28. Each screen panel 28 is configured to connect at least mechanically with the other screen panel 28 through the connector hinge 36. To such end, each screen panel 28 has an edge 134 configured to reversibly interlock with a corresponding connector switch 140 located on the spine 124 of the corresponding screen panel support structure 120. In various embodiments, when both screen panels 28 are interlocked with corresponding spines 124, the screen panels 28 may be pushed together to close the computer 20 and pulled apart to open the computer 20.

A connector switch 140 is shown in greater detail in FIG. 2B and may, e.g., be located in the center of a spine 124. In another example embodiment, and as shown in FIG. 2C, a connector switch 240 may be provided in the form of a USB port or other data connection. Connector hinges, screen panel support structures, and/or spines and/or blades of screen panel support structures could take various forms and have various dimensions in various embodiments, dependent, e.g., on screen panel size, weight, keyboard configuration, etc. It should be noted further that various configurations of connector switches could be used. For example, in some embodiments a given screen panel could be configured to connect with more than one connector switch provided along a spine of a screen panel support structure.

In various embodiments, a screen panel 28 may be configured to connect electrically as well as mechanically with another screen panel 28 through the connector hinge 36. In such embodiments, electrical terminals of a screen panel 28 could be reversibly connected with electrical connectors in a corresponding connector switch 140. Electrical wiring could be provided through the central hinge portion 104 and opposed movable connectors 112, thereby configuring the connector hinge 36 for receiving the screen panels 28 in a wired configuration in which the screen panels 28 may be used for wired communication with each other. In various embodiments the keyboard 40 may also be configured for reversible wired connection with the connector hinge 36 and thereby be configured for wired communication, e.g., with the processor 62 of the screen panel 28a, through the connector hinge 36.

Additionally or alternatively, a movable connector 112 may be configured for movement in two orthogonal directions. In such an embodiment, e.g., where a single such connector 112 is used to connect a screen panel support structure 120 to the central hinge portion 104, the screen panel support structure 120 and attached screen panel 28 may be twisted, causing the single movable connector 112 to rotate so that the screen 54 of the twisted screen panel 28 may be viewed from behind the computer 20. Some such configurations could support wired communication between screen panels 28 where the screen panels 28 are reversibly wired together through the central hinge portion 104, e.g., as previously discussed.

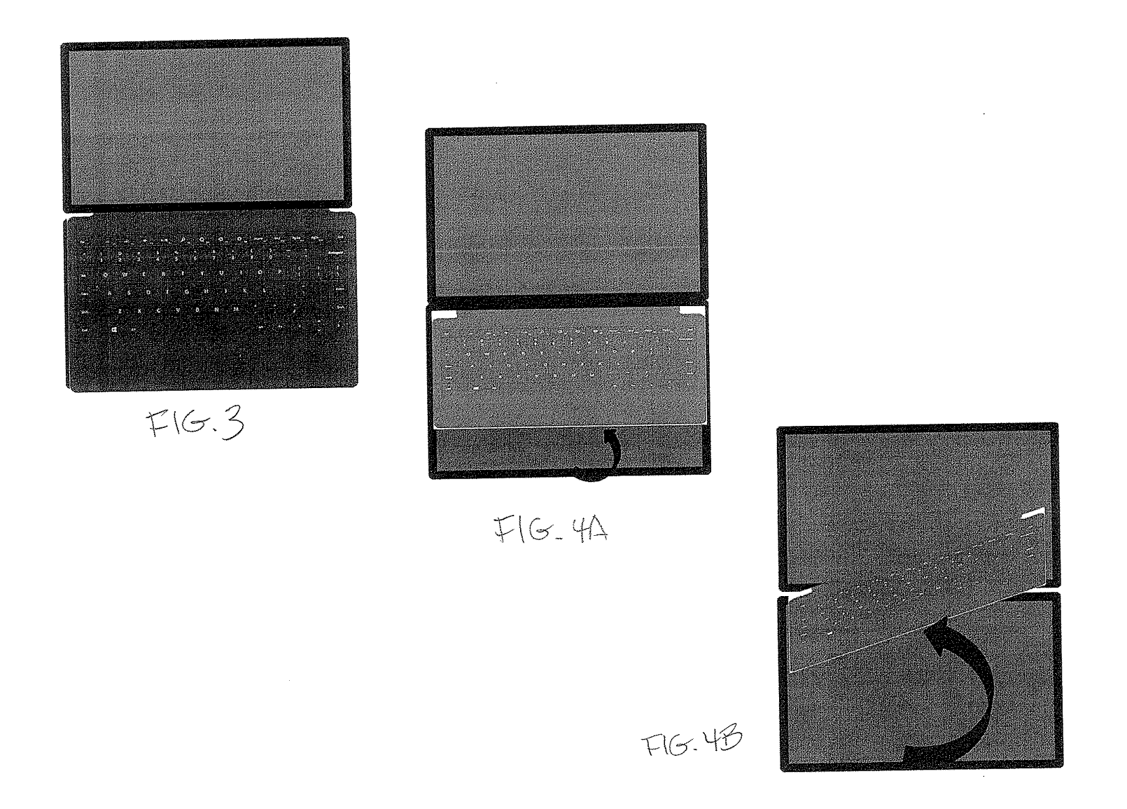

In one example implementation, when a user desires to operate the computer 20 as a laptop computer, the two screen panels 28 may be inserted and locked into the two screen panel support structures 120 via the connector switches 140. The user may position a first of the screen panels 28, e.g., onto a work surface, e.g., the user's lap, and may position the keyboard 40 onto the first screen panel 28 to obtain a laptop configuration, e.g., as shown in FIG. 3. As shown in FIGS. 4A and 4B, the keyboard 40 may lie over one of the screens and can be removed from it at will whenever needed.

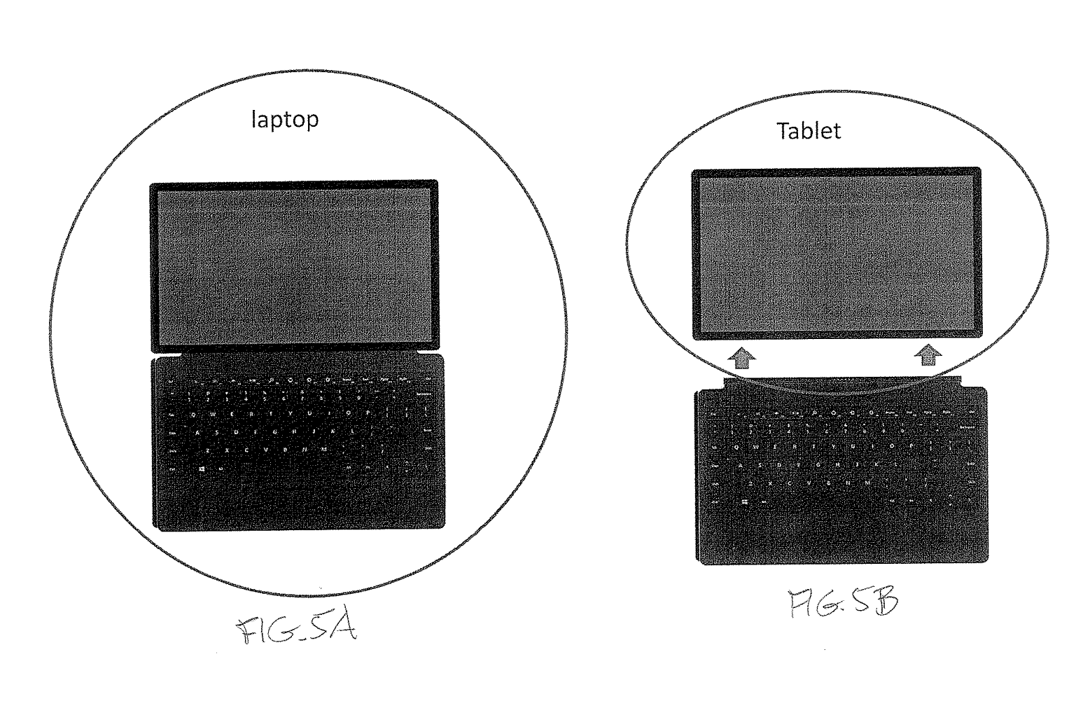

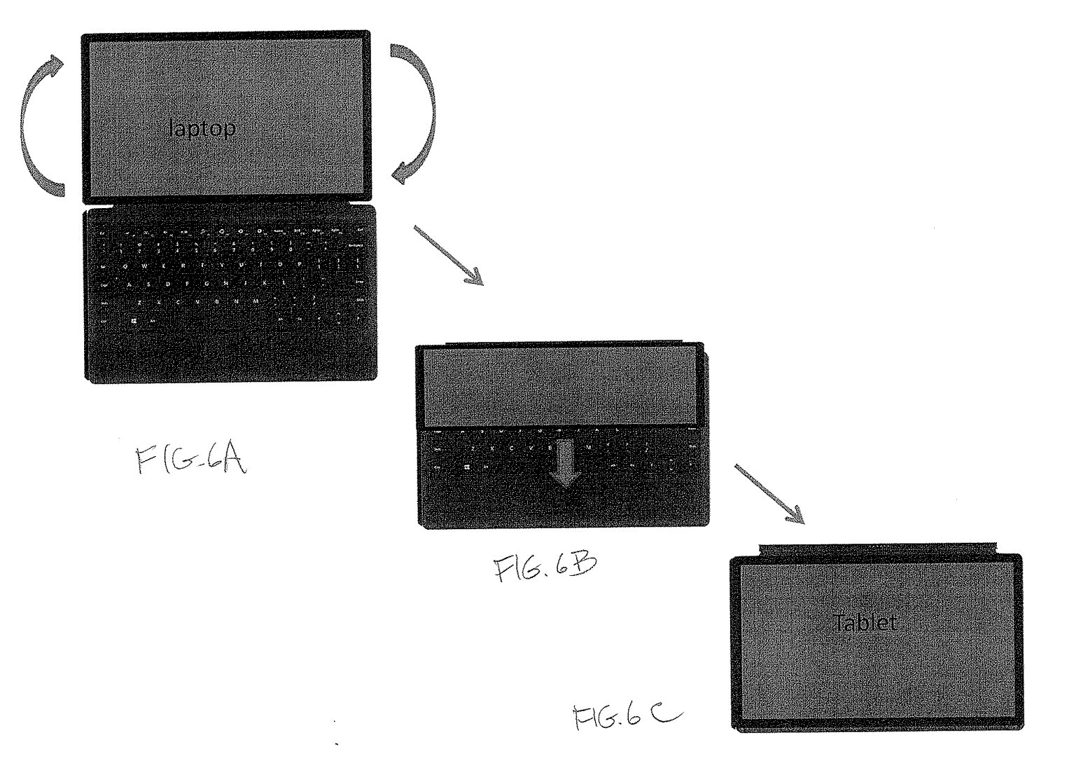

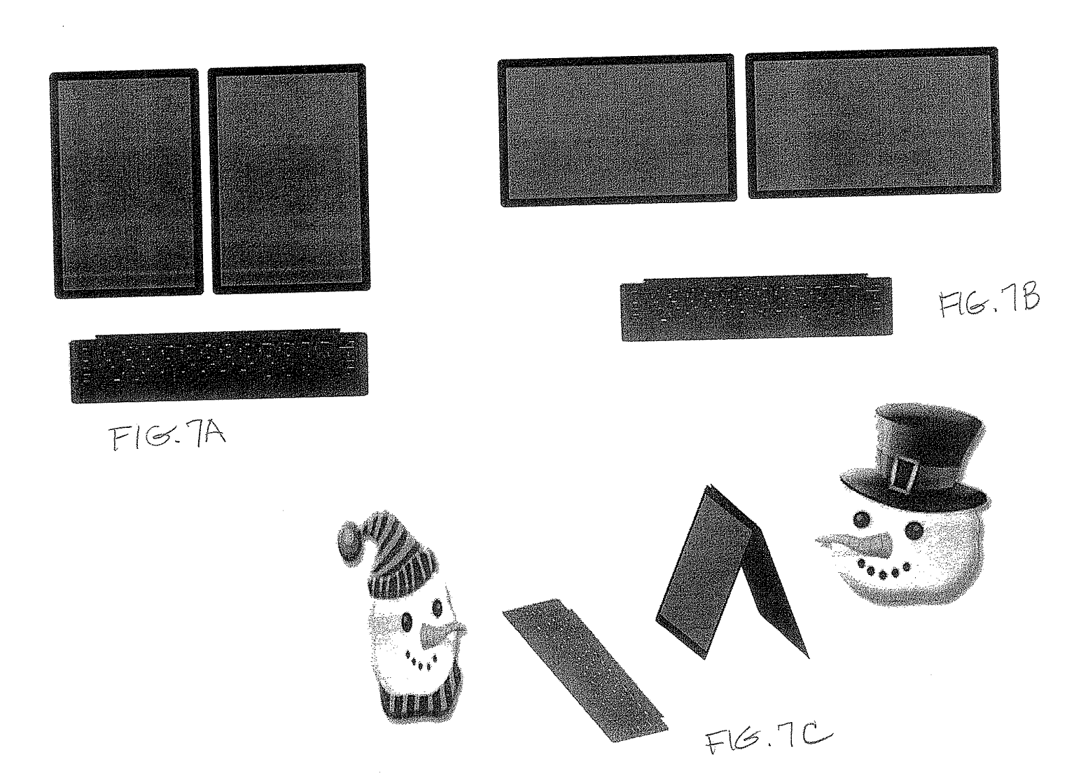

In another example implementation, a user may decide to use one of the screen panels 28 as a tablet computer. Accordingly, as shown in FIGS. 5A-5B and 6A-6C, the user may, e.g., detach the screen panel 28a, which includes the processor 62, from the connector hinge 36 and use the screen panel 28a as a tablet, e.g., in a standalone manner. In some implementations, the user may wirelessly connect the keyboard 40 with the screen panel 28a, e.g., so that a physical keyboard can be used instead of a virtual keyboard that might be software-provided on the screen panel 28a.

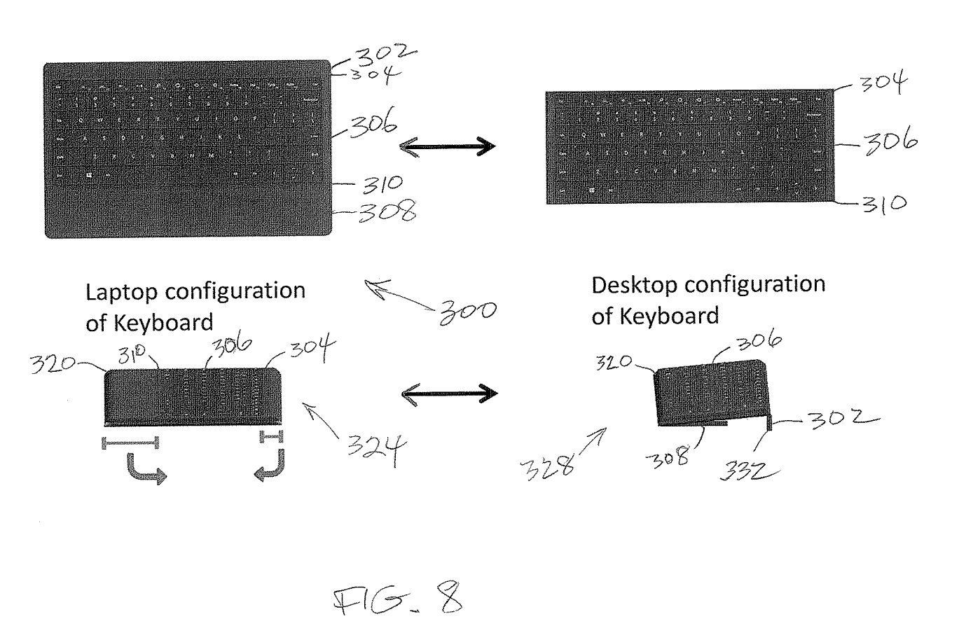

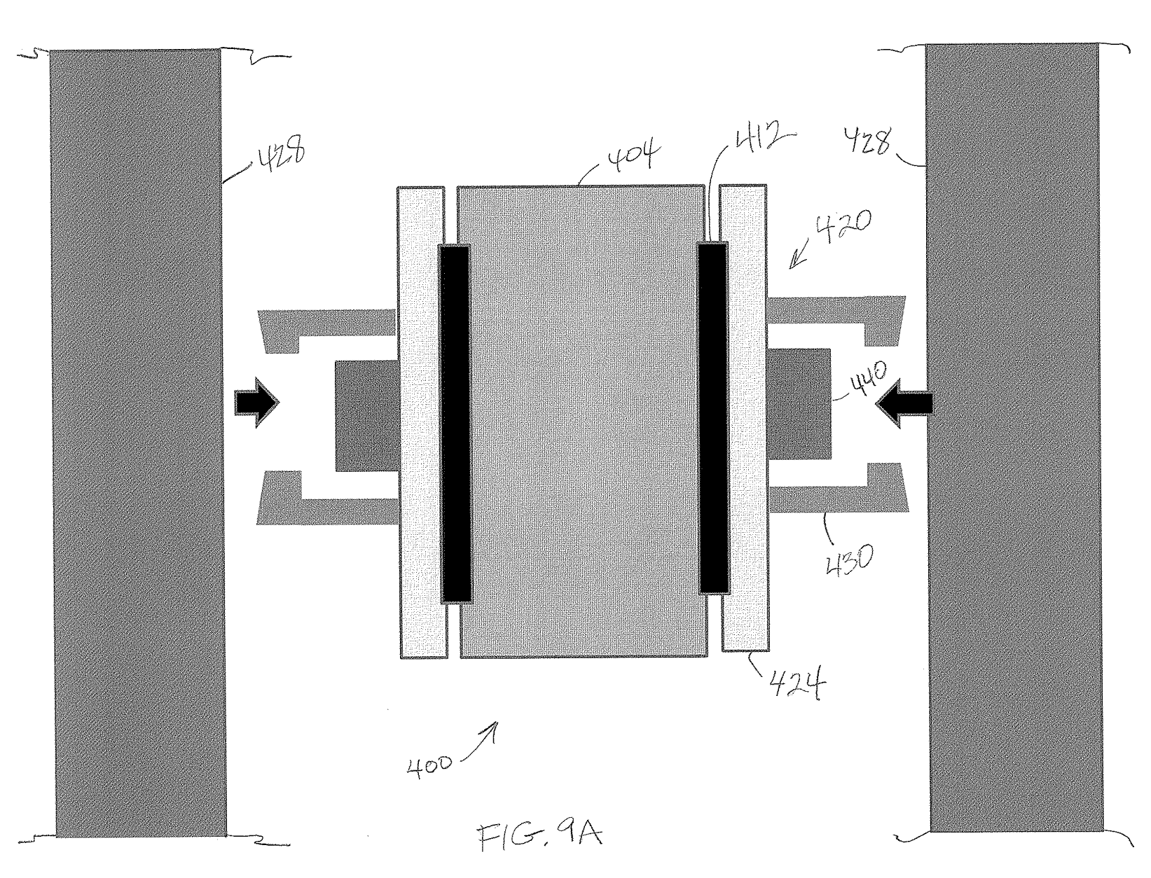

In various implementations, the computer 20 may be configured for use as a two-screen desktop computer. For example, a user may separate one or both screen panels 28 from the connector hinge 36 and position the screen panels 28 side-by-side, back-to-back, or in other positions on one or more work surfaces, e.g., as shown in FIGS. 7A through 7C. The user may also place the keyboard 40, e.g., onto a work surface and may operate the keyboard in wireless communication with the screen panels 28.

In some embodiments a screen panel 28 may provide a 13.3-inch or 14-inch screen, although other dimensions are possible in other configurations. In various embodiments, a modular computer may have a weight, e.g., of between about 3 and about 4 pounds, although other embodiments may be lighter or heavier. Screen panels 28 and the keyboard 40 may be configured for communication with one another and with other devices using, e.g., Bluetooth, WiFi, and/or other wireless standard(s) as may be appropriate.

In various embodiments, a keyboard may be convertible between a laptop configuration and a desktop configuration, e.g., by folding or unfolding the keyboard. An example embodiment of a foldable keyboard is indicated in FIG. 8 by reference number 300. Referring to the example modular computer 20 shown in FIG. 1, the keyboard 300 may be housed, e.g., between modular computer screen panels 28 in the same or a similar manner as the keyboard 40 and may be removed by a user, e.g., to perform wireless communication with the screen panel(s) 28. The keyboard 300 has a battery and transmitter/receiver (not shown) and may also be connectable with and detachable from the connector hinge 36. Additionally or alternatively, the keyboard 300 may be reversibly attached, e.g., clipped, to edges 44 of one of the screen panels 28, e.g., to edges 44 of the screen panel 28b as shown in FIG. 1.

The keyboard 300 has an upper portion 302 connected by a hinge structure 304 to a central key area 306 of the keyboard 300. A lower portion 308 of the keyboard 300 is connected by a hinge structure 310 to the central key area 306. The upper and lower portions 302 and 308 are each connected to a central key area 310. The keyboard 300 is made of metal or other suitable material and may have beveled edges 320.

A user may extend the upper and lower portions 302 and 308 away from the central key area 310 to place the keyboard 300, e.g., in a laptop configuration 324 in which the keyboard 300 lies substantially flat on a working surface. Additionally or alternatively, the user may fold the upper and lower portions 302 and 308 beneath the key area 320, to place the keyboard 300, e.g., in a desktop configuration 328 such that an upper edge 332 of the upper portion 302 rests on the work surface. The key area 306 is thereby partially elevated above the work surface, which can improve comfort of use. Of course, the user may choose to fold one of the upper and lower portions 302 and 308 beneath the key portion 306, without folding the other portion 302 or 308.

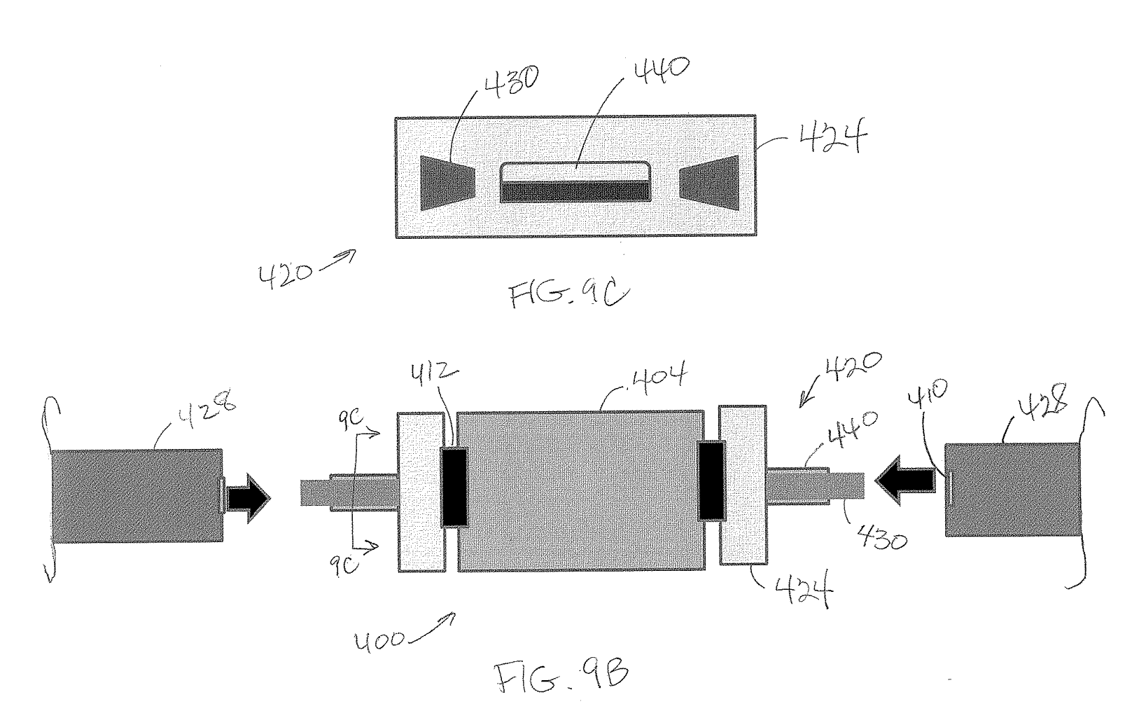

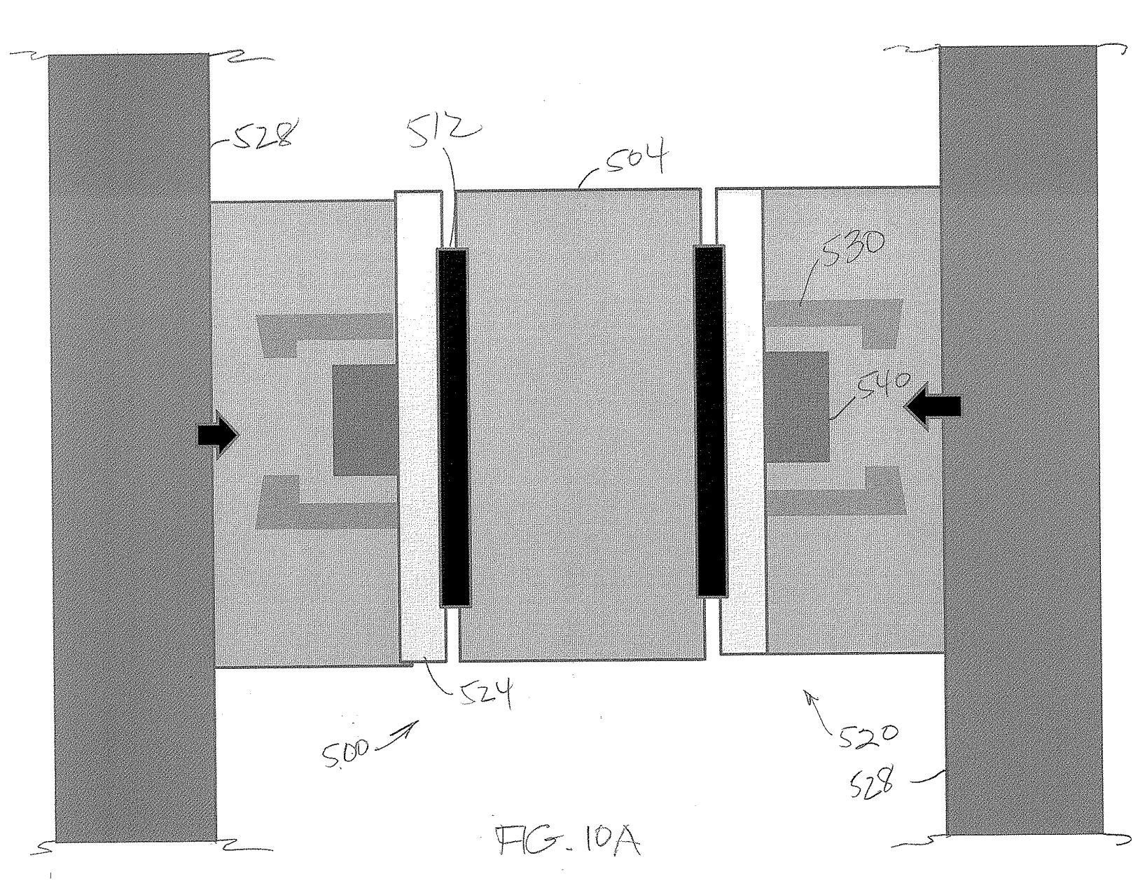

Another example embodiment of a connector hinge is shown in FIGS. 9A-9C. A connector hinge 400 includes a central hinge portion 404. At least two opposed connectors 412 are snugly connected with the central hinge portion 404 and movable relative to the central hinge portion 404, e.g., rotatable at least partially around the central hinge portion 404 and toward or away from each other. Although the central hinge portion 404 is shown in FIGS. 9A and 9B as having a rectangular edge profile, in other embodiments a central hinge portion may have another edge profile. For example, a central hinge portion may be cylindrical in shape, have an elliptical edge profile, etc.

Attached to each movable connector 412 is one of two screen panel connection structures 420. Each screen panel connection structure 420 has a spine 424 attached to one or more movable connector 412. Two locking mechanisms 430 extending from a given spine 424 are configured to lock a screen panel 428 in place when a connector 410 of the screen 428 is reversibly connected with a connector switch 440, which may be, e.g., a USB or other type of data port. In various embodiments, when both screen panels 428 are interlocked with corresponding spines 424, the screen panels 428 may be pushed together and/or apart to close and/or open a computer that includes the screen panels 428. A connection structure 420 is shown in greater detail in FIG. 9C.

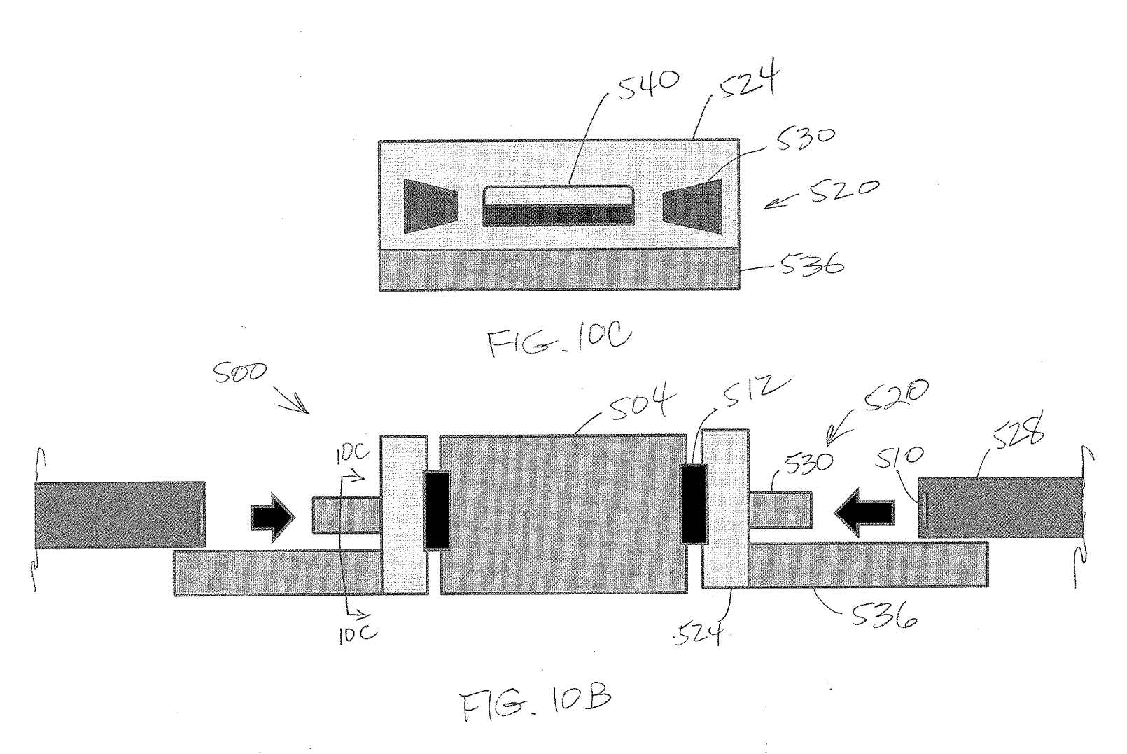

Another example embodiment of a connector hinge is shown in FIGS. 10A-10C. A connector hinge 500 includes a central hinge portion 504. At least two opposed connectors 512 are snugly connected with the central hinge portion 504 and movable relative to the central hinge portion 504, e.g., rotatable at least partially around the central hinge portion 504 and toward or away from each other. Although the central hinge portion 504 is shown in FIGS. 10A and 10B as having a rectangular edge profile, in other embodiments a central hinge portion may have another edge profile. For example, a central hinge portion may be cylindrical in shape, have an elliptical edge profile, etc.

Attached to each movable connector 512 is one of two screen panel connection structures 520. Each screen panel connection structure 520 has a spine 524 attached to one or more movable connector 512. Two locking mechanisms 530 extending from a given spine 524 are configured to lock a screen panel 528 in place when a connector 510 of the screen 528 is reversibly connected with a connector switch 540, which may be, e.g., a USB or other type of data port. A supporting ledge 536 is provided for each screen 528. In various embodiments, when both screen panels 528 are interlocked with corresponding spines 524, the screen panels 528 may be pushed together and/or apart to close and/or open a computer that includes the screen panels 528. A connection structure 520 is shown in greater detail in FIG. 10C.

Embodiments of the foregoing modular computer can provide a user, e.g., an executive or professional, with the functionality of a two-monitor desktop while the user is traveling and/or away from the office. The foregoing example embodiments make it possible for users to take advantage of touch-sensitive screens, solid-state hard drives, improved battery life and wireless connectivity with a keyboard and additional screen. Embodiments of modular computers are possible that are lightweight and not cumbersome, whether used as a tablet, laptop or desktop computer. Modular computers in accordance with various embodiments of the disclosure do not require an inordinate amount of space—a great advantage during travel, when it is often difficult to find space in which to set up a computer. Such embodiments are in contrast to currently and/or previously available two-screen computers, which can be heavy and uncomfortable to carry, can use large amounts of power, and can suffer from short battery life.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer comprising:
a processor;
first and second screen panels, the processor provided in the first screen panel; and
a connector hinge by which the first and second screen panels are reversibly connectible with each other.

2. The computer of claim 1, wherein the screen panels are configured for wireless communication with each other.

3. The computer of claim 1, wherein the screen panels are configurable for wired communication with each other.

4. The computer of claim 1, further comprising a keyboard reversibly housed between the screen panels.

5. The computer of claim 4, wherein each of the screen panels is capable of wireless communication with the other screen panel and/or the keyboard.

6. The computer of claim 1, the connector hinge comprising a screen panel support structure by which one of the screen panels is connected to the connector hinge.

7. The computer of claim 6, wherein one of the screen panels is rotatable at least partially around the connector hinge when affixed in the screen panel support structure.

8. The computer of claim 6, the screen panel support structure comprising a connector switch for reversibly affixing one of the screen panels in the screen panel support structure.

9. A method of operating a computer, the method comprising:
disconnecting at least one of a pair of screen panels from a connector hinge of the computer; and
operating a processor of at least one of the screen panels so as to provide wireless communication between the disconnected screen panels.

10. The method of claim 9, further comprising:
removing a keyboard from between the screen panels, and
using the keyboard to communicate wirelessly with each of the screen panels.

11. The method of claim 9, wherein disconnecting a screen panel from the connector hinge comprises reversibly disconnecting a wired connection through the connector hinge between the screen panels.

12. A modular computer comprising two screen panels, a processor in one of the screen panels, and a connector hinge to which the screen panels are connectible, at least one of the panels being removable from the connector hinge, the modular computer configurable to provide operability as (a) a laptop computer having one or two screens, (b) a single tablet computer, and/or (c) a desktop computer with one or two screens.

13. The modular computer of claim 12, further comprising a keyboard removably insertable between the two screen panels.

14. The modular computer of claim 13, wherein each of the screen panels is configured for wireless communication with the other screen panel and/or with the keyboard.

15. A keyboard comprising:
an upper portion, a lower portion, and a key area between the upper and lower portions;
the upper portion and/or lower portion being foldable relative to the key area.

16. The keyboard of claim 15, removably insertable between two screen panels of a modular computer.
